(19) United States
(12) Patent Application Publication
(10) Pub. No.: US 2020/0252715 A1
(43) Pub. Date: Aug. 6, 2020

(54) Wireless Earpiece and Control Method Therefor

(71) Applicant: Mobvoi Information Technology Co., Ltd., Beijing (CN)

(72) Inventors: Yu Zhou, Beijing (CN); Chensi Zhao, Beijing (CN); Sen Zeng, Beijing (CN)

(73) Assignee: Mobvoi Information Technology Co., Ltd., Beijing (CN)

(21) Appl. No.: 16/650,669

(22) PCT Filed: Jun. 29, 2018
(86) PCT No.: PCT/CN2018/093780

§ 371 Date: Mar. 25, 2020

(30) Foreign Application Priority Data
Sep. 26, 2017 (CN) 201710884484.4

(51) Int. Cl. H04R 1/10

(52) U.S. Cl. CPC H04R 1/1041; H04R 2420/07; H04R 2201/10; H04R 1/1016

(57) ABSTRACT

The embodiments of the present disclosure relate to the technical field of terminal applications and disclose a wireless earpiece and a control method therefor, the main purposes of which are achieving a control function by means of the wireless earpiece itself during the use of the wireless earpiece and improving the application flexibility of the wireless earpiece. The main technical solution of the present disclosure includes: a wireless earpiece body and a touch device. The touch device is disposed on the wireless earpiece body and is used for acquiring touch information and converting the touch information into a control signal so as to control the wireless earpiece body to perform a control command of the control signal. The present disclosure is mainly applied during the use of a real wireless stereo wireless earpiece.

The present application is based on and claims priority to Chinese Patent Application No. 201710884484.4, filed on Sep. 26, 2017, the content of which is incorporated herein by reference in its entirety.

### TECHNICAL FIELD

Embodiments of the present disclosure relate to the field of terminal applications, and more particularly, to a wireless earpiece and a control method for the wireless earpiece.

### BACKGROUND

With the popularity of portable electronic devices (such as smart phones), users' demand for earpieces, accessories of smart terminals, is also increasing. The earpieces can be used for listening to music alone without affecting others, or for separating the surrounding sound. The earpieces are very helpful for people in a noisy environment such as recording studios, DJs, travels, and sports.

At present, common earpieces include wired earpieces. Wired earpieces can communicate with the portable electronic device through a physical interface. A control button may be provided on a cable of the wired earpiece, such as a physical button for controlling the volume. The addition of the control button on the cable affects the portability of the wired earpiece, and the cable is likely to be entangled when used. Therefore, the wireless earpiece can solve the problem of convenience of the wired earpiece. The wireless earpiece communicates with the portable electronic device through a wireless connection method, such as Bluetooth.

In the process of implementing the above invention, the inventor found that in the existing art, since the wireless earpiece does not have a cable, it is impossible to add the control button to the cable. If the user wants to control the earpiece, the user can only manipulate the portable electronic device (such as a smart phone) connected to the wireless earpiece so as to achieve the purpose of controlling the wireless earpiece. This indirect way of controlling the wireless earpiece brings more inconvenience to the user.

### SUMMARY

In view of the above, the present disclosure provides a wireless earpiece and a control method for the wireless earpiece. The main object is to achieve the function control through the wireless earpiece itself when using the wireless earpiece and to increase the use flexibility of the wireless earpiece.

In a first aspect, the present disclosure provides a wireless earpiece. The wireless earpiece includes:

a wireless earpiece body; and

a touch device, where the touch device is disposed on the wireless earpiece body and is used for acquiring touch information and converting the touch information into a control signal so as to control the wireless earpiece body to perform a control command of the control signal.

Optionally, the touch device includes a touch panel, a touch sensor and a first process unit.

The touch panel is provided with a touch region, and the touch region is exposed outside the wireless earpiece body and is used for detecting the touch information within the touch region.

The touch sensor is connected to the touch panel and is used for converting the touch information into the control signal.

The first process unit is connected to the sensor and is used for controlling the wireless earpiece body to perform the control command of the control signal.

Optionally, the touch sensor includes a first sensitive element, a first convert element, and a first auxiliary power.

The first sensitive element is connected to the touch panel and is used for acquiring an analog signal corresponding to the touch information.

The first convert element is connected to the first sensitive element and is used for converting the analog signal into the control signal so as to control the wireless earpiece body to perform the control command of the control signal.

The first auxiliary power is connected to the first convert element and is used for supplying power to the first convert element.

Optionally, the touch device includes a detect unit, an acceleration sensor and a second process unit.

The detect unit is inside the wireless earpiece body and is used for detecting an acceleration and an acceleration direction of shaking of the wireless earpiece.

The acceleration sensor is connected to the detect unit and is used for converting the acceleration and the acceleration direction into the control signal.

The second process unit is connected to the acceleration sensor and is used for controlling the wireless earpiece body to perform the control command of the control signal.

Optionally, the acceleration sensor includes a second sensitive element, a second convert element and a second auxiliary power.

The second sensitive element is connected to the touch panel and is used for receiving an analog signal corresponding to the touch information.

The second convert element is connected to the second sensitive element and is used for converting the analog signal to the control signal.

The second auxiliary power is connected to the second convert element and is used for supplying power to the second convert element such that the wireless earpiece body is controlled to perform the control command of the control signal.

Optionally, the wireless earpiece body includes a wireless charging module. The wireless charging module is connected to the first auxiliary power or the second auxiliary power and is used for supplying power to the first auxiliary power or the second auxiliary power.

Optionally, the wireless earpiece body includes a wireless connection module, and the wireless connection module is used for wirelessly connecting to a terminal device so as to receive an audio signal sent by the terminal device.

The wireless connection module is one or more of an infrared connection module, a Bluetooth connection module, or a wireless fidelity connection module.

Optionally, the wireless earpiece body further includes a determining module and an indicating module.

The determining module is used for determining a state of a connection between the wireless connection module and the terminal device. When the connection is successful, the determining module sends to the indicating module light prompt information or prompt information indicative of the successful connection.

The indicating module is connected to the wireless connection module through the determining module and is used for executing the light prompt information or voice prompt information indicative of the successful connection.

Optionally, a detecting module is connected to the wireless charging module and is used for detecting a power amount state of the wireless charging module. In response to a low power amount, the detecting module sends to the indicating module light prompt information or voice prompt information indicative of the low power amount.

The indicating module is connected to the wireless charging module through the detecting module and is used for executing the light prompt information or voice prompt information indicative of the low power amount.

In a second aspect, the present disclosure provides a wireless earpiece control method. The method is applied to a wireless earpiece, and the wireless earpiece includes a wireless earpiece body and a touch device. The method includes the following steps.

A target operation instruction is acquired based on the touch device. The touch device is disposed on the wireless earpiece body of the wireless earpiece, and the target operation instruction is an operation instruction conforming to a preset control rule.

The target operation instruction is converted into a control signal. The preset control rule records a mapping relationship between the target operation instruction and the control signal.

A control command of the control signal is executed.

Optionally, the touch device includes a touch panel and a touch sensor.

Accordingly, acquiring a target operation instruction based on the touch device includes the following steps.

Gesture touch information is acquired based on the touch panel.

The gesture touch information is converted into the target operation instruction by using the touch sensor.

Optionally, the converting the gesture touch information into the target operation instruction by using the touch sensor includes the following steps.

The gesture touch information is compared with touch information in the preset control rule.

In response to determining that the gesture touch information is consistent with any touch information in the preset control rule, the gesture touch information is converted into the target operation instruction.

Optionally, the touch sensor includes a first sensitive element and a first convert element.

The converting the target operation instruction into control information includes the following steps.

An analog signal corresponding to the target operation instruction is acquired based on the first sensitive element.

The target operation instruction is converted into the control signal based on the first convert element.

Optionally, the touch device includes a detect unit and an acceleration sensor, and acquiring a target operation instruction based on the touch device includes the following steps.

An acceleration and an acceleration direction are detected based on the detect unit.

The acceleration and acceleration direction are converted into the target operation instruction by using the acceleration sensor.

Optionally, converting acceleration and acceleration direction into the target operation instruction by using the acceleration sensor includes the following steps.

The acceleration and acceleration direction are compared with touch information in the preset control rule.

In response to determining that the acceleration and acceleration direction are consistent with any touch information in the preset control rule, the acceleration and acceleration direction are determined as the target operation instruction.

Optionally, the acceleration sensor includes a second sensitive element and a second convert element.

The converting the target operation instruction into the control information includes the following steps.

An analog signal corresponding to the target operation instruction is acquired based on the second sensitive element.

The analog signal is converted to the control signal based on the second convert element.

According to the above technical solutions, the present disclosure provides a wireless earpiece and a control method for the wireless earpiece, the wireless earpiece includes a wireless earpiece body and a touch device, the touch device is disposed on the wireless earpiece body and is used for acquire touch information and converting the touch information into a control signal so as to control the wireless earpiece body to perform a control command of the control signal. In embodiments of the present disclosure, touch information triggered by a user is received though the touch device, and the touch information is converted into a touch signal executable by the wireless earpiece body. Compared with the existing art, embodiments of the present disclosure achieve flexible operation and control of the wireless earpiece without manipulating the portable electronic device (such as a smart phone) connected to the wireless earpiece.

The above is only a summary of the technical solutions of the embodiments of the present disclosure. In order to understand the technical means of the embodiments of the present disclosure more clearly and implement the technical means in accordance with the content of the specification, and to make the above and other objects, features, and advantages of the embodiments of the present disclosure more comprehensible, specific implementations of the embodiments of the present disclosure are given below.

### BRIEF DESCRIPTION OF THE DRAWINGS

Numerous additional advantages and benefits will become apparent to those of ordinary skill in the art upon reading the following detailed descriptions of the preferred embodiments. The drawings are merely used to illustrate the objectives of preferred embodiments and cannot be construed as limitations to the present disclosure. In the whole drawings, like reference numerals represent like components. In the drawings:

FIG. 1 is an architecture schematic diagram of a first type wireless earpiece according to an embodiment of the present disclosure;

FIG. 2 is a cross sectional view of the first type wireless earpiece according to an embodiment of the present disclosure;

FIG. 3 is a block diagram of a touch sensor according to an embodiment of the present disclosure;

FIG. 4 is a cross sectional view of a second type wireless earpiece according to an embodiment of the present disclosure;

FIG. 5 is an architecture schematic diagram of the second type wireless earpiece according to an embodiment of the present disclosure;

FIG. 6 is a flowchart of a wireless earpiece control method according to an embodiment of the present disclosure; and

FIG. 7 is an architecture schematic diagram of an apparatus according to an embodiment of the present disclosure.

### DESCRIPTION OF EMBODIMENTS

Exemplary embodiments of the present disclosure will be described below in greater detail with reference to the accompanying drawings. Although exemplary embodiments of the present disclosure are shown in the drawings, it should be understood that the present disclosure can be implemented in various forms and should not be limited by the embodiments set forth herein. On the contrary, these embodiments are provided to enable a thorough understanding of the present disclosure, and to fully convey the scope of the present disclosure to those skilled in the art.

An embodiment of the present disclosure provides a wireless earpiece. As shown in FIG. 1, the wireless earpiece includes a wireless earpiece body 11 and a touch device 12. The wireless earpiece body 11 is an appearance structure of the wireless earpiece. The wireless earpiece body 11 of the wireless earpiece shown in FIG. 1 is an in-ear type. In practical applications, the wireless earpiece body 11 may also be a headset type, an ear-hung type, or the like, which is not limited in specific embodiments of the present disclosure.

The touch device 12 is disposed on the wireless earpiece body 11. The touch device 12 is used for acquire touch information and converting the touch information into a control signal so as to control the wireless earpiece body 11 to perform a control command of the control signal.

The key difference between the embodiments of the present disclosure and the existing art is that a control instruction is received through the touch device 12. However, in the existing art, the control instruction is received through mechanical buttons. The touch device 12 may be integrated to a body position of the wireless earpiece through a flexible printed circuit (FPC), painting, printing, and the like, such that the touch device 12 is connected to the wireless earpiece body 11.

Embodiments of the present disclosure provides a wireless earpiece. The wireless earpiece includes the wireless earpiece body 11 and the touch device 12. The touch device 12 is disposed on the wireless earpiece body 12. The touch device 12 is used for acquire touch information and converting the touch information into a control signal so as to control the wireless earpiece body 11 to perform a control command of the control signal. In embodiments of the present disclosure, touch information triggered by a user is received though the touch device 12, and the touch information is converted into a touch signal executable by the wireless earpiece body 11. Compared with the existing art, embodiments of the present disclosure achieve flexible operation and control of the wireless earpiece without manipulating the portable electronic device (such as a smart phone) connected to the wireless earpiece.

In addition, compared with the existing art in which the wireless earpiece is controlled through mechanical buttons, in addition to the characteristic of controlling operations through the wireless earpiece itself, the wireless earpiece of the embodiments of the present disclosure also has a better waterproof characteristic, because the touch device 12 has a strong sealing, that is, the touch device 12 and the wireless earpiece body 11 in seamless connection.

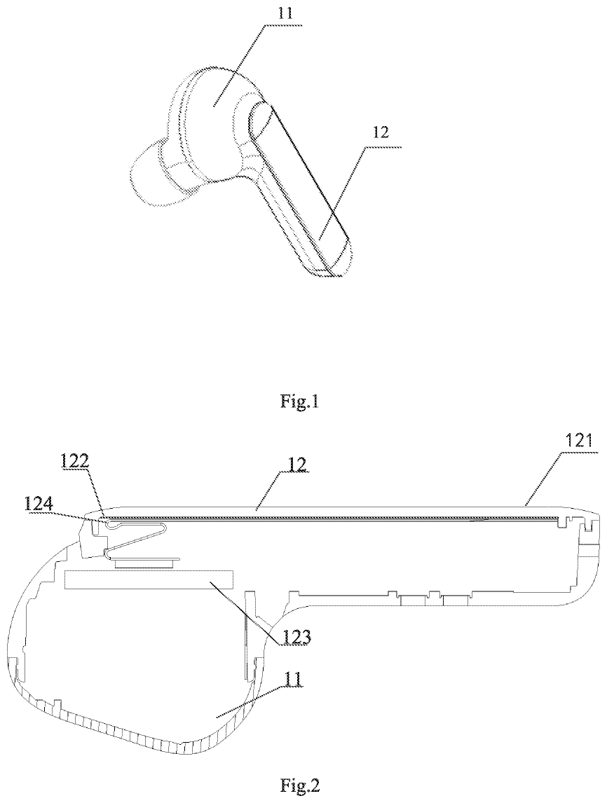

Further, embodiments of the present disclosure include two different types of touch devices 12. The first type of touch device 12 includes a touch panel, a touch sensor 122 and a first process unit (processor) 123 (as shown in FIG. 2). The second type of touch device includes a detect unit, an acceleration sensor and a second process unit (processor). The two types of touch devices 12 are different in the acquisition of the touch information, and are respectively described blew in details.

FIG. 2 is a cross sectional view of the first type wireless earpiece according to an embodiment of the present disclosure. As shown in FIG. 2, the touch panel 121 is provided with a touch region, and the touch region is exposed outside the wireless earpiece body. The touch region is used for detecting the touch information within the touch region. The touch sensor 122 is connected to the touch panel 121 and is used for converting the touch information into the control signal. The first process unit (processor) 123 is connected to the touch sensor 122 via an integrated wire 124, and is used for controlling the wireless earpiece body 11 to perform the control command of the control signal. In practical applications, the touch panel 121 may be a touch panel 121 made of glass, the larger the area of the touch panel 121, the more flexible the reception of the gesture instruction triggered by the user. The specific location of the first process unit 123 in the wireless earpiece is not limited in the embodiments of the present disclosure.

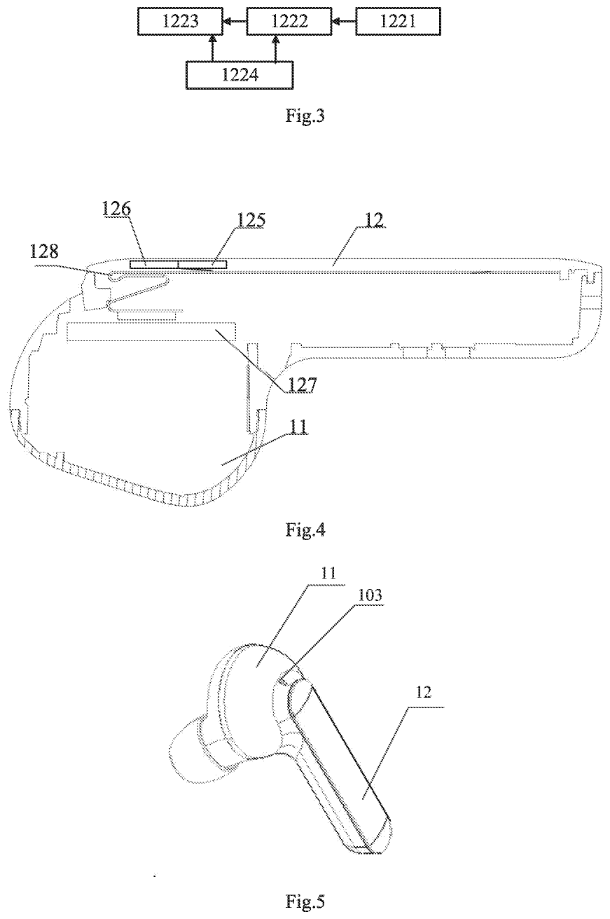

The touch panel 121 is used for receiving a measured object (for example, gesture operation). The touch sensor 122 includes multiple elements. FIG. 3 is a block diagram of the touch sensor according to an embodiment of the present disclosure. As shown in FIG. 3, the multiple elements are a first sensitive element 1221, a first convert element 1222, a first transform circuit 1223 respectively. The first sensitive element 1221 is mainly used for receiving an analog signal associated with the measured object (gesture touch). The first convert element 1222 is used for converting the analog signal outputted by the sensitive element into the control signal. Optionally, in order to facilitate the control of the first process unit, the touch sensor further includes the first transform circuit 1223, and the first transform circuit 1223 is used for executing on the control signal outputted by the first convert element 1222 processes such as amplification and modulation, such that a controller can identify the control signal quickly. In practical applications, the touch sensor 122 may further include a first auxiliary power 1224 for supplying power to the wireless earpiece (mainly for the first convert element 1222 and the first transform circuit 1223).

When a user touches the touch panel 121 of the wireless earpiece, the wireless earpiece receives the gesture touch information based on the touch panel 121. The first sensitive element 1221 acquires the gesture touch information. With the first convert element 1222 of the touch sensor 122, the analog signal corresponding to the gesture touch information is converted into the control signal. With the first transform circuit 1223 of the touch sensor 122, the control signal is amplified and modulated. The touch sensor 122 transmits the control signal to the processor 123 of the wireless earpiece, and the control signal is executed by the controller.

FIG. 4 is a cross sectional view of a second type wireless earpiece according to an embodiment of the present disclosure. As shown in FIG. 4, the touch device 12 includes a detect unit 125, an acceleration sensor 126 and a second process unit (processor) 127. The detect unit 125 is inside the wireless earpiece body 11 and is used for detecting an acceleration and an acceleration direction of shaking of the wireless earpiece. The acceleration sensor 126 is connected to the detect unit 125 and is used for converting the acceleration and the acceleration direction into the control signal. The second process unit (processor) 127 is connected to the acceleration sensor 126 through an integrated wire 128, and is used for controlling the wireless earpiece body to perform the control command of the control signal. In practical applications, the acceleration sensor 126 also includes multiple elements, and the multiple elements are a second sensitive element, a second convert element, a second transform circuit, and a second auxiliary power. For the functions implemented by these elements, reference can be made to the description associated with FIG. 3, which is not repeated the embodiment of the present disclosure. It should be noted that the second sensitive element and the first sensitive element mentioned above are essentially sensitive elements. The reason for using the description of the first sensitive element and the second sensitive element is to distinguish between the different types of the sensors where the sensitive elements are provided. The expressions “first” and “second” in the embodiments of the present disclosure do not represent other specific meanings. Similarly, the descriptions of first/second convert elements, first/second transform circuit, and first/second auxiliary powers are for the same reason.

FIG. 2 and FIG. 4 show two different types of wireless earpieces respectively. The two different types of wireless earpieces have the following difference. The conversion to the control signal is carried out by different objects, the conversion is performed by the touch sensor 122 in one type wireless earpiece, and the conversion is performed by the acceleration sensor 126 in the other type wireless earpiece. In practical applications, in order to enhance use functions of the wireless earpiece, one sensor may be mounted in one wireless earpiece, and the one sensor have both the function of the touch sensor 122 and the function of the acceleration sensor 126. In the control signal conversion, it is preferred to use the control signal with a better control signal magnitude, such that the controller of the wireless earpiece can respond to the operation of the user, thereby improving the user experience.

The above wireless earpiece may further include a wireless charging module. The wireless charging module is connected to the first auxiliary power or the second auxiliary power, and is used for supplying power and providing electrical energy to the auxiliary power. The wireless charging module can be understood as a coil inducible with an external wireless charging device. Of course, the wireless charging module may also be a solar panel. When the user is outdoors, the solar panel supplies power to the auxiliary power. The wireless charging module is not specifically limited in the present embodiment.

The above wireless earpiece may further include a wireless connection module, and the wireless connection module is used for wirelessly connecting to a terminal device so as to receive an audio signal sent by the terminal device. The wireless connection module is one or more of an infrared connection module, a Bluetooth connection module, or a wireless fidelity connection module. In practical applications, the terminal device is not limited to a smart phone, a tablet, a personal computer, a recorder, and the like; and the audio signal may be an audio signal outputted by the terminal device when receiving a call, or an audio signal outputted by the terminal device when playing a song or video. The specific embodiments of the present disclosure do not limit the type of the terminal device and the source of the audio signal.

As shown in FIG. 5, the above wireless earpiece further includes a determining module (not shown) and an indicating module 103. The determining module is used for determining a connection state between the wireless connection module and the terminal device. When the connection is successful, the determining module sends to the indicating module 103 light prompt information or prompt information indicative of the successful connection. The indicating module 103 is connected to the wireless connection module via the determining module and is used for executing the light prompt information or voice prompt information indicative of the successful connection. Exemplarily, when the wireless earpiece and the terminal device are connected successfully, the indicating module 103 flashes a green light for 5 times continuously, or broadcasts the prompt information of voice “connected successfully” in the form of voice broadcast. Optionally, when the connection between the wireless earpiece and the terminal device fails, the indicating module 103 flashes a red light for 2 times continuously and prompts the user of the terminal device by means of frequently flashing, or the indicating module 103 broadcasts the prompt information of voice “connection failed, please reconnect” in the form of voice broadcast, which is not specifically limited by the embodiments of the present disclosure.

The above wireless earpiece further includes a detecting module, and the detecting module is connected to the wireless charging module and is used for detecting a power amount state of the wireless charging module. In response to a low power amount, the detecting module sends to the indicating module 103 light prompt information or voice prompt information indicative of the low power amount. In embodiments of the present disclosure, the low power amount may be an empiric value. For example, when the power amount of the wireless earpiece is smaller than or equal to 20% of a total power amount, it may define that the wireless earpiece is with a low power amount. Alternatively, when the power amount of the wireless earpiece is smaller than or equal to 5% of a total power amount, it may define that the wireless earpiece is with a low power amount. Specifically, the low power amount of the wireless earpiece is not specifically limited in the embodiments of the present disclosure.

Upon receiving the light prompt information or voice prompt information indicative of the low power amount sent by the detecting module, the indicating module 103 performs the prompt information. For example, the indicating module 103 performs the prompt of flashing the red light for 5 times, or performs the voice prompt of “low power amount”, or performs the voice prompt of alarm sound, and the like. In order to enable the user to determine the current state of the wireless earpiece according to the prompt lights, the manner used by the indicating module 103 for prompting the successful connection between the wireless earpiece and the terminal device is different from the manner used by the indicating module 103 for prompting the low power amount.

Optionally, in addition to the above functions, when the wireless earpiece is being charged, the indicating module 103 also displays the corresponding charging state. For example, the wireless earpiece is in the charging process but is not fully charged, the red light is on continuously; and when the wireless earpiece is fully charged, the green light flashes for prompting.

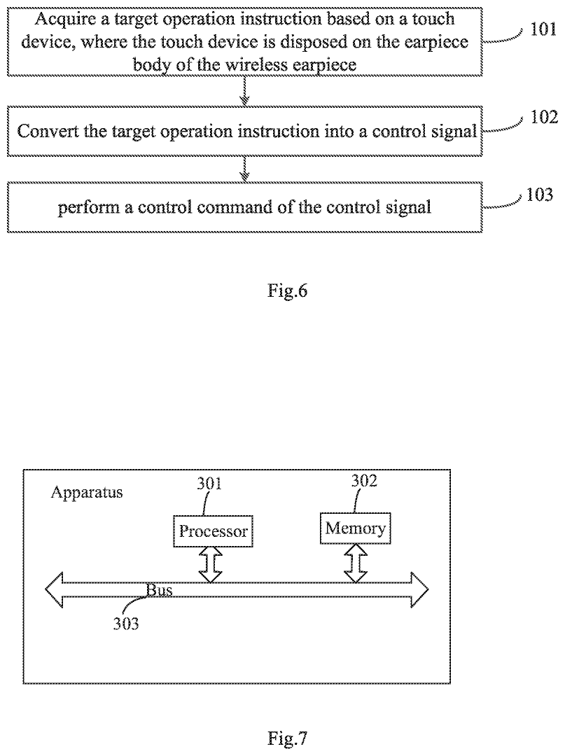

An embodiment of the present disclosure provides a wireless earpiece control method. The method is applied in the wireless earpiece shown in any one of FIG. 1 to FIG. 5. The wireless earpiece includes the wireless earpiece body and the touch device. As shown in FIG. 6, the method includes the following steps.

In step 201, a target operation instruction is acquired based on the touch device. The touch device is disposed on the wireless earpiece body of the wireless earpiece, and the target operation instruction is an operation instruction conforming to a preset control rule.

In addition to the wireless earpiece shown in any one of FIG. 1 to FIG. 5, the wireless earpiece of the embodiments of the present disclosure is not limited to the following types of wireless earpieces: a headset type and an ear-hung type. The wireless earpiece may be an accessory of a portable electronic device (such as a smartphone, a tablet, etc.). The wireless earpiece may also be an independent apparatus, which can use the Universal Serial Bus (USB) and play sound through inserted mobile storage products, the USB flash and U disk. For ease of description, the following embodiments are described with an example in which the wireless earpiece is an accessory of the smart phone and is an in-ear earphone. But it should be noted that such description is not intended to limit the specific types of the wireless earpiece. The embodiment of the present disclosure does not limit the style and type of the wireless earpiece.

For ease of description, please continue to refer to FIG. 2, the wireless earpiece includes a wireless earpiece body, an integrated circuit and a touch device. The wireless earpiece body is an appearance structure of the wireless earpiece. The touch device is used for receiving and executing control information. The touch device is further used for sensing operations triggered by the user, and transforming it to a machine instruction identifiable to the wireless earpiece. The integrated circuit is used for connecting the touch device and the wireless earpiece body.

The key difference between the embodiments of the present disclosure and the existing art is that a control instruction is received through the touch device. However, in the existing art, the control instruction is received through mechanical buttons. In practical applications, the touch device mainly includes a touch panel/detect unit, a sensor, and a controller. FIG. 2 illustrates an example in which the sensor is a touch sensor. The touch device is integrated to a body position of the wireless earpiece through a flexible printed circuit (FPC), painting, printing, and the like, such that the touch device is connected to the wireless earpiece body.

Compared with the existing art in which the wireless earpiece is controlled through mechanical buttons, in addition to the characteristic of controlling operations through the wireless earpiece itself, the wireless earpiece of the embodiments of the present disclosure also has a better waterproof characteristic, because the touch device has a strong sealing, that is, the touch device and the wireless earpiece body 11 in seamless connection.

When the wireless earpiece is successfully connected to the smart phone in a wireless manner, with the wireless earpiece, the user can listen to songs, answer a call, and so on. An application scenario is provided. When a user is wearing the wireless earpiece of the embodiments of the present disclosure and listening to a song, and wants to adjust the volume of the song, the user can operate the touch device of the wireless earpiece to control the volume. The user touches the touch device with the finger. Firstly, the receives the operation instruction of the user and identifies the meaning represented by the operation instruction. The basis for identifying the operation instruction is the preset control rule in the wireless earpiece. If the operation instruction received by the wireless earpiece is contained in the preset control rule in the wireless earpiece, the operation instruction received this time is acquired and determined as the target operation instruction, and it proceeds to perform step 202. If the operation instruction received by the wireless earpiece is not contained in the preset control rule, the operation instruction received this time is omitted and the present adjusting control is terminated.

The preset control rule has been configured when the wireless earpiece is delivered from the factory, the user may reconfigure the preset control rule after purchasing the wireless earpiece, and the specification is not limited in embodiments of the present disclosure. Exemplarily, the preset control rule records which operation instructions can be used as the target operation instruction. For example, the preset control rule specifies that the target operation instruction includes sliding upward and sliding downward, but does not record an operation instruction of sliding leftward and an operation instruction of sliding rightward. Assuming the user performs a sliding-upward operation on the touch sensor, the wireless earpiece determines the operation instruction of this operation as the target operation instruction and proceeds to perform step 202. Assuming that the user performs a sliding-rightward operation on the touch sensor, since an operation instruction of sliding rightward is not recorded in the preset control rule, the wireless earpiece identifies that the operation is a false operation and ignores the sliding-upward operation performed by the user.

In step 202, the target operation instruction is converted into the control signal. The mapping relationship between the target operation instruction and the control signal is recorded in the preset control rule.

The touch device, as a detect device, not only can sense specified measured objects (touch operation, acceleration, and the like), but also can convert the target operation instruction acquired in step 201 into a usable control signal according to a certain rule. In an embodiment of the present disclosure, the control signal is a usable electrical signal, and the control signal can be read, identified and performed by the touch device shown in FIG. 2 so as to implement the control of the wireless earpiece.

In addition to the target operation instruction, the preset control rule further records the mapping relationship between the target operation instruction and the control signal. In order to accurately control the wireless earpiece without fault, the mapping relationship in the embodiments of the present disclosure is an one-to-one correspondence, as shown Table 1. For example, when the received target operation instruction is sliding upward, the touch device converts the target operation instruction into the control signal, and the control signal indicates increasing the current sound volume. When the received target operation instruction is a double-click operation, the touch device converts the target operation instruction into the control signal, and the control signal indicates pausing the current song. Table 1 illustrates exemplary examples, but it does not mean that the wireless earpiece in practical applications only has the target operation instructions in Table 1 and their corresponding control signal meanings. The number of target operation instructions, the number of control signals, and the correspondence relationship are not limited in embodiments of the present disclosure.

TABLE 1

| Target operation instruction | Control signal |
|---|---|
| Sliding upward | Volume + |
| Sliding downward | Volume − |
| Double clicking | Next music |
| Single clicking | Pause/Hang up |
| . . . . . . | . . . . . . |

In step 203, a control command of the control signal is executed.

Steps 201 and 202 are both carried out by the sensor. When the touch device completes the conversion of the control signal, the control information is performed. For example, after receiving the control signal of “Volume +”, the touch device immediately performs the adjusting control of increasing the sound of the wireless earpiece.

Embodiments of the present disclosure provide a wireless earpiece control method. The target operation instruction is acquired based on the touch device. The touch device is disposed on the wireless earpiece body of the wireless earpiece. The target operation instruction is an operation instruction conforming to the preset control rule. The target operation instruction is converted into the control signal. The mapping relationship between the target operation instruction and the control signal is recorded in the preset control rule. The control command of the control signal is executed. In embodiments of the present disclosure, touch information triggered by a user is received though the touch device, and the touch information is converted into a touch signal executable by the wireless earpiece body. Compared with the existing art, embodiments of the present disclosure do not need to manipulate the portable electronic device (such as a smart phone) connected to the wireless earpiece, and thus achieve flexible operation and control of the wireless earpiece. In addition, in the embodiments of the present disclosure, the target operation instruction triggered by the user is received by the touch device provided in the wireless earpiece body, it does not need to arrange mechanical buttons on the wireless earpiece, thereby achieving flexible control of the wireless earpiece without affecting the overall structure and appearance of the wireless earpiece.

As a detailed description and extension of the above embodiments, when the target operation instruction is acquired based on the touch device in step 201, the target operation instruction can be implemented based on a touch sensor and an acceleration sensor. Manners for acquiring the touch operation instruction are respectively described below in details.

In the manner one, the touch device includes a touch panel, a touch sensor and a first control unit (controller).

Gesture touch information is acquired based on the touch panel, and the gesture touch information is converted into the target operation instruction by using the touch sensor.

The touch panel is used for receiving a measured object (for example, gesture operation). The touch sensor includes multiple elements, which are a first sensitive element, a first convert element, and a first transform circuit respectively. The first sensitive element is mainly used for receiving a physical quantity signal (analog signal) associated with the measured object (gesture touch). With the first convert element, the analog signal is converted into the control signal. The first transform circuit is used for executing on the control signal processes such as amplification and modulation, such that the controller can identify the control signal corresponding to the control information quickly. In practical applications, the touch sensor may further include a first auxiliary power for supplying power to the wireless earpiece (mainly for the first convert element and the first transform circuit).

When a user touches the touch panel of the wireless earpiece, the wireless earpiece receives the gesture touch information based on the touch panel. The touch panel senses the gesture touch information (that is, the physical quantity signal) of the touching, and compares the gesture touch information with touch information in the preset control rule. If the gesture touch information does not conform to any touch information of the preset control rule in Table 1, the gesture touch of the local user is omitted. If the gesture touch information conforms to any touch information of the preset control rule in Table 1, the gesture touch information is converted into the target operation instruction, and the acquisition of the physical quantity information is completed by the wireless earpiece.

After acquiring the physical quantity information (target operation instruction), the wireless earpiece acquires the analog signal corresponding to the target operation instruction based on the first sensitive element, and converts the analog signal to the control signal based on the first convert element. The touch sensor transmits the control signal to the controller of the wireless earpiece, and the controller performs the control signal.

Exemplarily, the used answers a call with the wireless earpiece of embodiments of the present disclosure. During the call, the user triggers the touch panel of the wireless earpiece and performs a single-click gesture on the touch panel. The single-click gesture operation is determined as the target operation instruction (physical quantity information) based on the preset control rule. Further, the analog signal corresponding to the target operation instruction is acquired through the first sensitive element, the analog signal is converted into the control signal through the first convert element, the control signal is transmitted to the controller of the wireless earpiece, and the controller performs the operation of hanging up the phone.

In the manner two, the touch device includes a detect unit, an acceleration sensor and a second process unit (controller).

Acquiring the target operation instruction based on the touch device specifically includes: detecting an acceleration and an acceleration direction based on the detect unit, and converting the acceleration and the acceleration direction into the target operation instruction by using the acceleration sensor.

The acceleration sensor includes multiple elements, which are a second sensitive element, a second convert element, a second transform circuit, and a second auxiliary power respectively. The elements of the acceleration sensor have the same functions as the elements of the touch sensor described in the manner one. For the function of each element of the acceleration sensor, please refer to the related detailed description in the manner, which is not repeated in the embodiment of the present disclosure.

In this manner, the user can control the wireless earpiece by shaking the earpiece, that is, when the user is wearing the wireless earpiece, the user controls the wireless earpiece by shaking head.

When determining whether the user is shaking the wireless earpiece, the wireless earpiece may monitor, through the acceleration sensor, whether the wireless earpiece itself is in a shaking state. If the wireless earpiece is in the shaking state, the wireless earpiece acquires the acceleration and the acceleration direction of the acceleration based on the sensitive element in the acceleration sensor, and compares the acceleration and the acceleration direction with the touch information in the preset control rule. If the acceleration and the acceleration direction are consistent with any touch information in the preset control rule, the acceleration and the acceleration direction are determined as the target operation instruction.

Table 2 shows a part of the preset control rule. As shown in Table 2, when the wireless earpiece detects a single shaking to the right, the wireless earpiece determines the present shaking as the target operation instruction. Generally, when the user intentionally shakes the wireless earpiece, the shaking will generate an acceleration, which can control the adjusting magnitude of the volume. The greater the acceleration, the larger/smaller the adjusting magnitude will be. It should be noted that Table 2 is only an example description and is not a specific limitation of the preset control rule.

TABLE 2

| Target operation instruction | Control signal |
|---|---|
| Single shaking to right | Volume + |
| Single shaking to left | Volume − |
| Continuously shaking to right | Next music |
| and left twice | |
| Continuously shaking to right | Pause/Hang up |
| and left for three times | |
| . . . . . . . | . . . . . . |

After determining the target operation instruction, the wireless earpiece converts the acceleration and the acceleration direction into the control information based on the convert element in the acceleration sensor, and converts the control information into the control signal based on the transform circuit in the acceleration sensor.

With reference to Table 2, exemplarily, the user listens to music with the wireless earpiece provided by embodiments of the present disclosure. When the received target operation instruction is continuously shaking to right and left twice, the acceleration sensor converts the target operation instruction into the control signal, and the control signal represents playing the next music. When the received target operation instruction is continuously shaking to right and left for three times, the acceleration sensor converts the target operation instruction into the control signal, and the control signal represents pausing the present song. Table 2 illustrates exemplary examples, but it does not mean that the wireless earpiece in practical applications only has the target operation instructions in Table 2 and their corresponding control signal meanings. The number of target operation instructions, the number of control signals, and the correspondence relationship are not limited in embodiments of the present disclosure.

In the present embodiment, the target operation instruction in the preset control rule is limited for distinguishing between occasional shaking and the intentional shaking action of the user, or for distinguishing between a shaking action for other operation function and the action of shaking the wireless earpiece in the present embodiment. The preset control rule has been configured when the wireless earpiece is delivered from the factory, or the preset control rule may be configured, in a configuring stage, by the user through shaking the wireless earpiece, which is not specifically limited.

In practical applications, when the wireless earpiece shakes, the detect unit can detect the generation of the acceleration, acquire the direction of the acceleration, and transmits it to the acceleration sensor. During the configuration of the target operation instruction, the wireless earpiece can configure the target operation instruction according to shaking data (whether an acceleration is generated, the magnitude of the acceleration, the direction of the acceleration, and the like) returned by the acceleration sensor. In a feasible solution of this embodiment, since the acceleration sensor can not only detect whether gravity acceleration is generated, but also can detect the magnitude of the acceleration, the wireless earpiece can also determine, according to the acquired specific data including the acceleration and the acceleration direction, the shaking degree for distinguishing, thereby enriching the number of the target operation instructions.

Generally, the acceleration generated through softly shaking the wireless earpiece by the user is less than the gravity acceleration generated through hard shaking the wireless earpiece. In the configuration of the target operation instructions, the wireless earpiece may perform segment division based on the magnitude of the acceleration. The shaking action of the user is allowed to be configured to be harder, while the shaking action of another function is configured to be softer, such that two different operations are distinguished. With the continuous increase of functions of the wireless earpiece, the limited types of shaking operations will not meet the increasing number of functions. In this solution, the wireless earpiece provides another way in the dimension of the acceleration magnitude (reflected in the user's usage level, it is the shaking strength), the number of shaking operations is increased in multiples in combination with the existing shaking operations, thereby enriching the operation mode of the wireless earpiece.

An embodiment of the present disclosure provides a storage medium storing a program. The program, when executed by a processor, implements the wireless earpiece control method.

An embodiment of the present disclosure provides a processor. The processor is used for running a program. When the program is run, the wireless earpiece control method is performed.

An embodiment of the present disclosure provides a device. As shown in FIG. 7, the device includes a processor 301, a memory 302 and a program stored in the memory 302 and executable by the processor. The communication between the processor 301 and the memory 302 is implemented by a bus 303.

When executing the program, the processor 301 implements the following steps.

A target operation instruction is acquired based on a touch device. The touch device is disposed on a wireless earpiece body of a wireless earpiece, and the target operation instruction is an operation instruction conforming to a preset control rule.

The target operation instruction is converted into a control signal. The preset control rule records a mapping relationship between the target operation instruction and the control signal.

A control command of the control signal is executed.

Optionally, the touch device includes a touch panel and a touch sensor.

Accordingly, acquiring the target operation instruction based on the touch device includes the following steps.

Gesture touch information is acquired based on the touch panel.

The gesture touch information is converted into the target operation instruction by using the touch sensor.

Optionally, converting the gesture touch information into the target operation instruction by using the touch sensor includes the following steps.

The gesture touch information is compared with touch information in the preset control rule.

In response to determining that the gesture touch information is consistent with any touch information in the preset control rule, the gesture touch information is converted into the target operation instruction.

Optionally, the touch sensor includes a first sensitive element and a first convert element.

The converting the target operation instruction into control information includes the following steps.

An analog signal corresponding to the target operation instruction is acquired based on the first sensitive element.

The target operation instruction is converted into the control signal based on the first convert element.

Optionally, the touch device includes a detect unit and an acceleration sensor, and acquiring a target operation instruction based on the touch device includes the following steps.

An acceleration and an acceleration direction are detected based on the detect unit.

The acceleration and acceleration direction are converted into the target operation instruction by using the acceleration sensor.

Optionally, converting acceleration and acceleration direction into the target operation instruction by using the acceleration sensor includes the following steps.

The acceleration and acceleration direction are compared with touch information in the preset control rule.

In response to determining that the acceleration and acceleration direction are consistent with any touch information in the preset control rule, the acceleration and acceleration direction are determined as the target operation instruction.

Optionally, the acceleration sensor includes a second sensitive element and a second convert element.

The converting the target operation instruction into the control information includes the following steps.

An analog signal corresponding to the target operation instruction is acquired based on the second sensitive element.

The analog signal is converted to the control signal based on the second convert element.

Optionally, executing the control command of the control signal includes the following step.

The control signal is transmitted to a controller of the wireless earpiece, and the control signal is executed by the controller. The controller communicates with the touch device via an integrated circuit.

An apparatus in the present disclosure may be a wireless earpiece in any form.

The present application further provides a computer program product. When executed on a data process apparatus, the computer program product is adapted to execute program codes initialized with the following method steps.

A target operation instruction is acquired based on a touch device. The touch device is disposed on a wireless earpiece body of a wireless earpiece, and the target operation instruction is an operation instruction conforming to a preset control rule.

The target operation instruction is converted into a control signal. The preset control rule records a mapping relationship between the target operation instruction and the control signal.

A control command of the control signal is executed.

An embodiment of the present disclosure further discloses A1 a wireless earpiece. The wireless earpiece includes:

a wireless earpiece body; and

a touch device, where the touch device is disposed on the wireless earpiece body and is used for acquiring touch information and converting the touch information into a control signal so as to control the wireless earpiece body to perform a control command of the control signal.

A2, the wireless earpiece according to claim A1,

The touch device includes a touch panel, a touch sensor and a first process unit.

The touch panel is provided with a touch region, and the touch region is exposed outside the wireless earpiece body and is used for detecting the touch information within the touch region.

The touch sensor is connected to the touch panel and is used for converting the touch information into the control signal.

The first process unit is connected to the sensor and is used for controlling the wireless earpiece body to perform the control command of the control signal.

A3, the wireless earpiece according to claim A2,

The touch sensor includes a first sensitive element, a first convert element and a first auxiliary power.

The first sensitive element is connected to the touch panel and is used for acquiring an analog signal corresponding to the touch information.

The first convert element is connected to the first sensitive element and is used for converting the analog signal into the control signal so as to control the wireless earpiece body to perform the control command of the control signal.

The first auxiliary power is connected to the first convert element and is used for supplying power to the first convert element.

A4, the wireless earpiece according to claim A1,

The touch device includes a detect unit, an acceleration sensor and a second process unit.

The detect unit is inside the wireless earpiece body and is used for detecting an acceleration and an acceleration direction of shaking of the wireless earpiece.

The acceleration sensor is connected to the detect unit and is used for converting the acceleration and the acceleration direction into the control signal.

The second process unit is connected to the acceleration sensor and is used for controlling the wireless earpiece body to perform the control command of the control signal.

A5, the wireless earpiece according to claim A4, the acceleration sensor includes a second sensitive element, a second convert element and a second auxiliary power.

The second sensitive element is connected to the touch panel and is used for receiving an analog signal corresponding to the touch information.

The second convert element is connected to the second sensitive element and is used for converting the analog signal to the control signal.

The second auxiliary power is connected to the second convert element and is used for supplying power to the second convert element such that the wireless earpiece body is controlled to perform the control command of the control signal.

A6, the wireless earpiece according to claim A3 or A5, the wireless earpiece body includes a wireless charging module. The wireless charging module is connected to the first auxiliary power or the second auxiliary power and is used for supplying power to the first auxiliary power or the second auxiliary power.

A7, the wireless earpiece according to claim A6, the wireless earpiece body includes a wireless connection module, and the wireless connection module is used for wirelessly connecting to a terminal device so as to receive an audio signal sent by the terminal device.

The wireless connection module is one or more of an infrared connection module, a Bluetooth connection module, or a wireless fidelity connection module.

A8, the wireless earpiece according to claim A7, the wireless earpiece body further includes a determining module and an indicating module.

The determining module is used for determining a state of a connection between the wireless connection module and the terminal device. When the connection is successful, the determining module sends to the indicating module light prompt information or prompt information indicative of the successful connection.

The indicating module is connected to the wireless connection module through the determining module and is used for executing the light prompt information or voice prompt information indicative of the successful connection.

A9, the wireless earpiece according to claim A8.

A detecting module is connected to the wireless charging module and is used for detecting a power amount state of the wireless charging module. In response to a low power amount, the detecting module sends to the indicating module light prompt information or voice prompt information indicative of the low power amount.

The indicating module is connected to the wireless charging module through the detecting module and is used for executing the light prompt information or voice prompt information indicative of the low power amount.

B10, a wireless earpiece control method is provided. The method is applied to a wireless earpiece, and the wireless earpiece includes a wireless earpiece body and a touch device. The method includes the following steps.

A target operation instruction is acquired based on the touch device. The touch device is disposed on the wireless earpiece body of the wireless earpiece, and the target operation instruction is an operation instruction conforming to a preset control rule.

The target operation instruction is converted into a control signal. The preset control rule records a mapping relationship between the target operation instruction and the control signal.

A control command of the control signal is executed.

B11, the method according to claim B10, the touch device includes a touch panel and a touch sensor.

Accordingly, acquiring a target operation instruction based on the touch device includes the following steps.

Gesture touch information is acquired based on the touch panel.

The gesture touch information is converted into the target operation instruction by using the touch sensor.

B12, the method according to claim B11, the converting the gesture touch information into the target operation instruction by using the touch sensor includes the following steps.

The gesture touch information is compared with touch information in the preset control rule.

In response to determining that the gesture touch information is consistent with any touch information in the preset control rule, the gesture touch information is converted into the target operation instruction.

B13, the method according to claim B12, the touch sensor includes a first sensitive element and a first convert element.

The converting the target operation instruction into control information includes the following steps.

An analog signal corresponding to the target operation instruction is acquired based on the first sensitive element.

The target operation instruction is converted into the control signal based on the first convert element.

B14, the method according to claim B10, the touch device includes a detect unit and an acceleration sensor.

Accordingly, acquiring a target operation instruction based on the touch device includes the following steps.

An acceleration and an acceleration direction are detected based on the detect unit.

The acceleration and acceleration direction are converted into the target operation instruction by using the acceleration sensor.

B15, the method according to claim B14, converting acceleration and acceleration direction into the target operation instruction by using the acceleration sensor includes the following steps.

The acceleration and acceleration direction are compared with touch information in the preset control rule.

In response to determining that the acceleration and acceleration direction are consistent with any touch information in the preset control rule, the acceleration and acceleration direction are determined as the target operation instruction.

B16, the method according to claim B14, the acceleration sensor includes a second sensitive element and a second convert element.

The converting the target operation instruction into the control information includes the following steps.

An analog signal corresponding to the target operation instruction is acquired based on the second sensitive element.

The analog signal is converted to the control signal based on the second convert element.

In the above embodiments, the descriptions of various embodiments are emphasized differently, and a reference for the part not described in detail in an embodiment can be made to related descriptions of other embodiments.

It can be understood that the relevant features in the above device can be mutually referenced. In addition, the terms “first”, “second” and the like in the above embodiments are used for distinguishing various embodiments, and do not represent the advantages and disadvantages of the embodiments.

Those skilled in the art can clearly understand that, for ease and conciseness of description, the specific working processes of the system, device, and units described above can refer to the corresponding processes in the foregoing method embodiments, and are not repeated here.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present disclosure is not described with reference to any particular programming language. It is appreciated that a variety of programming languages may be used to implement the teachings of the present disclosure as described herein, and any references to specific languages are provided for disclosure of enablement and best mode of the present disclosure.

In the specification provided herein, numerous specific details are described. However, it is to be understood that the embodiments of the present disclosure can be practiced without these specific details. In some examples, well-known structures and techniques are not shown in detail in order not to obscure the understanding of the specification.

Similarly, it should be understood that various features of the present disclosure sometimes are grouped into a single embodiment, drawing or description thereof in the above descriptions of the exemplary embodiments of the present disclosure for the sake of simplifying the disclosure and helping understanding one or more of various disclosure aspects. However, the disclosed device should not be interpreted as reflecting the following intention: the claimed disclosure requires more features than those expressly recited in each claim. Rather, as reflected by following claims, the disclosure aspects are less than all features of a single embodiment disclosed above. Accordingly, a claim following a specific embodiment is hereby expressly incorporated into this embodiment, wherein each claim serves as an individual embodiment of the present disclosure.

Those skilled in the art can understand that the components of the device in an embodiment can be adaptively modified and arranged in one or more devices different from the embodiment. The components in an embodiment may be combined into one component, and in addition, they may be divided into a plurality of sub-components. Except that at least some of such features are mutually exclusive, all of the features disclosed in the present description (including accompanying claims, abstract and drawings) and all components of any device disclosed so can be combined in any combination. Unless explicitly stated otherwise, each feature disclosed in the present description (including accompanying claims, abstract, and drawings) can be replaced by an alternative feature that provides the same, equivalent, or similar purpose.

In addition, those skilled in the art can understand that although some embodiments described herein include some features included in other embodiments rather than other features, combinations of features of different embodiments are meant to be within the scope of the present invention and form different embodiments. For example, in the following claims, any one of the claimed embodiments can be used in any combination manner. Various component embodiments of the present invention may be implemented by hardware, or in a combination thereof.

The various component embodiments of the present disclosure may be implemented in hardware, or in software modules running on one or more processors, or in a combination thereof. Those skilled in the art should understand that a microprocessor or a digital signal processor (DSP) may be used in practice to implement some or all functions of some or all of the components in the wireless earpiece and the wireless earpiece control method according to embodiments of the present disclosure. Features. The present disclosure may also be implemented as a device or device program (e.g., a computer program and a computer program product) for performing part or all of the methods described herein. Such a program that implements the present disclosure may be stored on a computer-readable medium or may have the form of one or more signals. Such signals can be downloaded from an Internet website, provided on a carrier signal, or provided in any other form.

It should be noted that the above embodiments are intended to illustrate the present disclosure rather than to limit the present invention, and alternative embodiments can be devised by those skilled in the art without departing from the scope of the appended claims. In the claims, any reference symbols between brackets should not be constructed as limitations to the claims. The term “comprising” does not preclude the presence of a component or assembly that is not listed in the claims. The terms “a” or “an” before a component or assembly do not preclude the presence of a plurality of such components or assemblies. The present invention can be implemented by means of a device comprising a plurality of different components. In a claim in which a plurality of components are listed, the plurality of such components can be embodied by the same component item. The use of the terms “first”, “second”, “third” and the like does not represent any order. Such terms can be interpreted as names.

1. A wireless earpiece, comprising:
a wireless earpiece body; and
a touch device, wherein the touch device is disposed on the wireless earpiece body and is used for acquire touch information and converting the touch information into a control signal so as to control the wireless earpiece body to perform a control command of the control signal.

2. The wireless earpiece of claim 1, wherein the touch device comprises a touch panel, a touch sensor and a first process unit,
the touch panel is provided with a touch region, the touch region is exposed outside the wireless earpiece body and is used for detecting the touch information within the touch region,
the touch sensor is connected to the touch panel and is used for converting the touch information into the control signal, and
the first process unit is connected to the touch sensor and is used for controlling the wireless earpiece body to perform the control command of the control signal.

3. The wireless earpiece of claim 2, wherein the touch sensor comprises a first sensitive element, a first convert element and a first auxiliary power,
the first sensitive element is connected to the touch panel and is used for acquiring an analog signal corresponding to the touch information,
the first convert element is connected to the first sensitive element and is used for converting the analog signal into the control signal so as to control the wireless earpiece body to perform the control command of the control signal, and
the first auxiliary power is connected to the first convert element and is used for supplying power to the first convert element.

4. The wireless earpiece of claim 2, wherein the touch device further comprises a detect unit, an acceleration sensor and a second process unit,
the detect unit is inside the wireless earpiece body and is used for detecting an acceleration and an acceleration direction of shaking of the wireless earpiece,
the acceleration sensor is connected to the detect unit and is used for converting the acceleration and the acceleration direction into the control signal, and
the second process unit is connected to the acceleration sensor and is used for controlling the wireless earpiece body to perform the control command of the control signal.

5. The wireless earpiece of claim 4, wherein the acceleration sensor comprises a second sensitive element, a second convert element and a second auxiliary power,
the second sensitive element is connected to the touch panel and is used for receiving an analog signal corresponding to the touch information,
the second convert element is connected to the second sensitive element and is used for converting the analog signal to the control signal, and
the second auxiliary power is connected to the second convert element and is used for supplying power to the second convert element such that the wireless earpiece body is controlled to perform the control command of the control signal.

6. The wireless earpiece of claim 3, wherein the wireless earpiece body comprises a wireless charging module, the wireless charging module is connected to the first auxiliary power and is used for supplying power to the first auxiliary power.

7. The wireless earpiece of claim 6, wherein the wireless earpiece body comprises a wireless connection module, and the wireless connection module is used for wirelessly connecting to a terminal device so as to receive an audio signal sent by the terminal device,
wherein the wireless connection module is one or more of an infrared connection module, a Bluetooth connection module, or a wireless fidelity connection module.

8. The wireless earpiece of claim 7, wherein the wireless earpiece body further comprises a determining module and an indicating module,
the determining module is used for determining a state of a connection between the wireless connection module and the terminal device, and when the connection is successful, sending to the indicating module light prompt information or prompt information indicative of the successful connection,
the indicating module is connected to the wireless connection module through the determining module and is used for executing the light prompt information or voice prompt information indicative of the successful connection.

9. The wireless earpiece of claim 8, wherein the wireless earpiece body further comprises a detecting module, which is connected to the wireless charging module and is used for detecting a power amount state of the wireless charging module, wherein in response to a low power amount, the detecting module sends to the indicating module light prompt information or voice prompt information indicative of the low power amount,
the indicating module is connected to the wireless charging module through the detecting module and is used for executing the light prompt information or voice prompt information indicative of the low power amount.

10. A wireless earpiece control method, the method being applied to a wireless earpiece, the wireless earpiece comprising a wireless earpiece body and a touch device, wherein the method comprises:
acquiring a target operation instruction based on the touch device, where the touch device is disposed on the wireless earpiece body of the wireless earpiece, and the target operation instruction is an operation instruction conforming to a preset control rule;
converting the target operation instruction into a control signal, wherein the preset control rule records a mapping relationship between the target operation instruction and the control signal; and
executing a control command of the control signal.

11. A non-transitory storage medium storing a program, wherein the program, when executed by a processor, implements the wireless earpiece control method of claim 10.

12. An apparatus, comprising:
a processor, a memory, and a program stored in the memory and executable on the processor,
steps of execution of the program by the processor comprise:
acquiring a target operation instruction based on a touch device, where the touch device is disposed on a wireless earpiece body of a wireless earpiece, and the target operation instruction is an operation instruction conforming to a preset control rule;
converting the target operation instruction into a control signal, wherein the preset control rule records a mapping relationship between the target operation instruction and the control signal; and
executing a control command of the control signal.

13. The wireless earpiece of claim 1, further comprising an acceleration sensor and a processor, wherein the acceleration sensor is used for detecting an acceleration and acceleration direction of the wireless earpiece, and the processor is used for determining a control command corresponding to the acceleration and acceleration direction, wherein the control command comprises: increasing a sound volume, decreasing a sound volume, next music, pausing, and hanging up.

14. The wireless earpiece of claim 13, wherein the processor determines the control command corresponding to the acceleration and acceleration direction according to a preset control rule, and a mapping relationship between the acceleration and acceleration direction and the control command is recorded in the preset control rule.

15. The wireless earpiece of claim 14, wherein the processor determines whether the acceleration and acceleration direction detected by the acceleration sensor is recorded in the preset control rule, and discards the acceleration and acceleration direction in response to determining that the acceleration and acceleration direction detected by the acceleration sensor is not recorded in the preset control rule.

16. The wireless earpiece of claim 13, wherein the processor determines a shaking direction and a number of shaking of the wireless earpiece according to the acceleration and acceleration direction detected by the acceleration sensor, and determines the control command based on the shaking direction and the number of shaking of the wireless earpiece.

17. The wireless earpiece of claim 13, wherein the control command is to increase or decrease a sound volume of the wireless earpiece, the processor determines an increasing or decreasing amount of the sound volume according to a magnitude of the acceleration detected by the acceleration sensor.

18. The wireless earpiece of claim 13, wherein the processor determines whether the control command is to increase a sound volume of the wireless earpiece or decreasing the sound volume according to the acceleration direction detected by the acceleration sensor.

19. The wireless earpiece of claim 1, wherein the touch device comprises a touch panel and a processor, and the touch panel is provided with a touch region, wherein in response to receiving a clicking operation of a user on the touch region, the processor determines whether the control command is pausing or next music according to a number of clicking detected by the touch panel.

20. The wireless earpiece of claim 1, wherein the touch device comprises a touch panel and a processor, and the touch panel is provided with a touch region, wherein in response to receiving a sliding operation of a user on the touch region, the processor determines whether the control command is to increase a sound volume of the wireless earpiece or decreasing the sound volume according to a direction of the sliding operation detected by the touch panel.
